(19) United States
(12) Patent Application Publication
(10) Pub. No.: US 2008/0051529 A1
(43) Pub. Date: Feb. 28, 2008

(54) Method and Device for the Gradual Production of Polymers Using Melt Condensation

(76) Inventor: Rudolf Kampf, Grundau (DE)

Correspondence Address: DARBY & DARBY P.C., P.O. BOX 770, Church Street Station, New York, NY, 10008-0770, US

(21) Appl. No.: 11/572,241

(22) PCT Filed: Jul. 2, 2005
(86) PCT No.: PCT/EP05/07171

§ 371 Date: Sep. 19, 2007

(30) Foreign Application Priority Data
Jul. 17, 2004 (DE) 10 2004 034 708.5

(51) Int. Cl. C08F 2/01

(52) U.S. Cl. 526/66; 422/134

(57) ABSTRACT

Disclosed are a method and a device for batchwise production of high-molecular polyphosphonates, polysulfones, polyarylates, polyamides, polyarylene ethers, or polyether ketones by melt-condensing a monomer compound carrying hydroxyl groups, carboxyl groups, anhydride groups, phosphoric acid groups, phosphono groups, phosphonate groups, phosphino groups, phosphinate groups, carbonyl groups, sulfonyl groups, sulfonate groups, siloxane groups or amino groups on its own or along with at least one diphenol, dialcohol, diamine, or a dicarbonate component. According to the invention, a) esterification or reesterification and precondensation are performed in a batchwise operated first reactor (1) in the presence of an esterification catalyst or reesterification catalyst; b) polycondensation is then optionally performed in a batchwise operated intermediate reactor (6) by optionally adding one or several additional monomers, another catalyst, and additives until a predetermined polycondensation level or viscosity level has been attained; and finally (c) condensation is continued in a batchwise operated final reactor (12) until the desired polycondensation level or viscosity level has been reached; and d) branching molecules comprising more than two functional groups are optionally added prior to or during esterification or reesterification, prior to or during polycondensation optionally performed in the intermediate reactor, or prior to or during polycondensation performed in the final reactor. The dwell time in the reactors ranges between 5 minutes and 15 hours while the temperature is set to 180 to 300° C. in reactors (1) and (6) and to 240 to 400° C. in reactor (12), the pressure being continuously or gradually lowered from 2000 to 100 mbar in reactors (1) and (6) and to 100 to 0.01 mbar in reactor (12) by sucking off the vapors produced during condensation.

### CROSS-REFERENCE TO RELATED APPLICATION

This application is a 371 National Stage of International Patent Application No. PCT/EP2005/007171, filed on Jul. 2, 2005, which claims priority from German Patent Application No. 10 2004 034 708.5, filed on Jul. 14, 2004, both of which are incorporated by reference herein. The International Application was published in German on Jan. 26, 2006 as WO 2006/007966 A1 under PCT Article 21(2).

### FIELD OF THE INVENTION

The subject of the invention is a method and a device for batchwise production of high-molecular polyphosphonates, polysulfones, polyarylates, polyamides, polyarylene ethers, or polyether ketones by melt condensation of a monomer compound carrying hydroxyl groups, carboxyl groups, anhydride groups, phosphoric acid groups, phosphono groups, phosphonate groups, phosphino groups, phosphinate groups, carbonyl groups, sulfonyl groups, sulfonate groups, siloxane groups or amino groups on its own or along with at least one diphenol, dialcohol, diamine, or a dicarbonate component.

The invention moreover concerns a method for production of polymers and copolymers with long or short-chain single or multiple branchings, having star, comb, bush, tree or dendrimer shaped branching structures in a regular or statistical distribution.

### SUMMARY OF THE PRIOR ART

In the method known from DE 3 111 653 for production of polyphosphonates, using customary laboratory procedures and methods, one produces polyphosphonates in several stepwise occurring steps from dihydroxyl-diphenyl or other bisphenols or phenyl esters of methylphosphonic acid. Examples of other polymers produced on a laboratory scale will be found in D. Braun, H. Cherdron, H. Ritter “Praktikum der makromolekularen Stoffe” [Practicum in macromolecular substances], Wiley-VCH Verlag, Weinheim, 1999.

These publications describe distillations and methods involving lowering the pressure while at the same time bringing in nitrogen on a laboratory scale. These methods involve considerable costs and an effort only tolerable on a laboratory scale. This allows one to achieve a favorable ratio of volume to wall surface and, thus, very good heat transfer rates, such as could never be achieved in an industrial apparatus. Thus, for example, the volume increases as the third power of the radius, while the wall surface only rises with the square of the radius. For example, the ratio of volume to wall surface for a half-full 1-liter round bottom flask is 1.9 and for a half-full 2000-liter spherical tank it is 2.6. Hence, either longer dwell times need to be accepted or surface losses need to be counterbalanced by heat-transferring installed structures. If the reaction also puts out cleavage products, which need to diffuse out from the reaction mass, this also reduces the surface as a ratio of the volume. This leads either to longer dwell times or to the installation of elements such as stirring devices to produce an intense circulation of the reaction volume.

It is therefore understandable that the transfer of a method carried out on a laboratory scale to industrial production facilities usually cannot be done directly and changes are absolutely necessary to the course of the method. In many cases, especially when producing polymers, one cannot tolerate working with longer dwell times, since the high temperatures normally employed would result in decomposition and breakdown reaction of the polymer.

Therefore, the problem arises of eliminating the above-mentioned drawbacks by attuning the course of the method and the design of the device used for it in such a way that no decomposition or breakdown reactions of the polymer occur. The invented method is therefore characterized in that the polymers produced from monomers by melt condensation under a vacuum with short dwell times have practically no discoloration and no gel content. This is achieved by producing a precondensate in a multistaged method, at first at low temperatures under slight thermal stress, and then subjecting it to a polycondensation and final condensation at higher temperatures in special reactors.

It has turned out that the stirred-tank reactors or series of such reactors, which have proven themselves in batchwise precondensation and as regards conversion and dwell spectrum for melts, are not the optimal solution for highly viscous products. One needs also to consider the fact that, when the reaction volumes are very high, the effectiveness of the stirrer and the installed parts which hinder a circulatory flow likewise have a major influence on the distribution of the monomers and the polycondensates in the reaction space. Too long a dwell time in poorly circulating reactors and on heat exchanger surfaces is detrimental in the case of polymerization processes with a tendency to side reactions, which particularly impair the color quality. If the dwell time at such zones is too long, a breakdown will occur on the polymer chains in competition to the chain growth, especially during polycondensation reactions.

Most plastics have the unpleasant attribute of melting and dripping when they catch fire.

These drawbacks can be avoided by building brancher molecules into the polymer chain and the branches. By adding branchers, the rheological properties can be altered so that a dripping under action of heat no longer occurs.

Furthermore, one can create comb, bush and/or star-shaped polymer skeletons by the number and type of branching points, with special properties inherent in them. Thus, in particular, a few long-chain branches are able to favorably influence the rheological recovery capacity in film blowing, also known as onion formation, so that especially thin and stable films can be drawn or ribbed glass slabs extruded.

### SUMMARY OF THE INVENTION

The underlying problem of the invention is to create polyphosphonates, polysulfones, polyarylates, polyamides, polyarylene ethers, or polyether ketones with the most uniform and narrowest possible distribution of molecular weight by melt condensation. The products obtained should have no black particles, and at most a very slight yellow coloration, and practically no gel content, despite long or short-chain branching points.

This problem is solved by a method for batchwise production of high-molecular polyphosphonates, polysulfones, polyarylates, polyamides, polyarylene ethers, or polyether ketones by melt-condensation of a monomer compound carrying hydroxyl groups, carboxyl groups, anhydride groups, phosphoric acid groups, phosphono groups, phosphonate groups, phosphino groups, phosphinate groups, carbonyl groups, sulfonyl groups, sulfonate groups, siloxane groups or amino groups on its own or along with at least one diphenol, dialcohol, diamine, or a dicarbonate component, wherein

a) an esterification or reesterification and a precondensation are performed in a batchwise operated first reactor 1 in the presence of an esterification and reesterification catalyst;

b) a polycondensation is then optionally performed in a batchwise operated intermediate reactor 6 by optionally adding one or several additional monomers, another catalyst, and additives, until a predetermined polycondensation level or viscosity level has been attained; and finally

(c) the poly-transesterification is continued in a batchwise operated final reactor 12 until the desired polycondensation level or viscosity level has been reached,

d) branching molecules comprising more than two functional groups are optionally added,

prior to or during esterification or reesterification,
prior to or during polycondensation optionally performed in the intermediate reactor,
or prior to or during polycondensation performed in the final reactor,
   wherein a dwell time in the reactors between 5 minutes and 15 hours is observed, the temperature is set to 180 to 300° C. in reactors 1 and 6 and to 240 to 400° C. in reactor 12, and the pressure is continuously lowered from 2000 to 100 mbar in reactor 1 and in the intermediate reactor 6 and to 100 to 0.01 mbar in the final reactor 12 during the course of the dwell time by sucking off the vapors produced during the condensation.

Under the mentioned conditions, primarily bush-like long and short-chain branchings are formed in the intermediate reactor 6, while statistical and comblike branchings are formed in the final reactor 12.

### BRIEF DESCRIPTION OF THE DRAWINGS

FIG. 1 shows a layout for batchwise polycondensation of polybisphenyl phosphonates, polycarbonates, polyarylates.

FIG. 2 shows a layout for batchwise polycondensation and rectification.

FIG. 3 shows a layout for batchwise polycondensation and rectification.

### DETAILED DESCRIPTION OF THE INVENTION

One preferred method consists in that the precondensate obtained in the first reactor (1) is taken directly to the final reactor (12) while at the same time adding one or more additional monomers, an additional catalyst, and possibly other additives, and omitting the intermediate reactor (6), and a polycondensation is performed there until achieving a predetermined level of polycondensation or viscosity, while the monomers escaping with the cleavage products formed during the condensation reactions are collected as condensates and then subjected to distillation.

Another preferred method is characterized in that the monomers escaping as vapor together with the cleavage products during the production of the precondensate in the first reactor (1) are returned to the first reactor (1), while the cleavage products are transferred to the outside as condensates and the precondensate formed in the first reactor is taken directly to the final reactor (12) after adding one or more additional monomers, an additional catalyst, and possibly other additives, and omitting the intermediate reactor (6), and a polycondensation is performed there until achieving a predetermined level of polycondensation or viscosity.

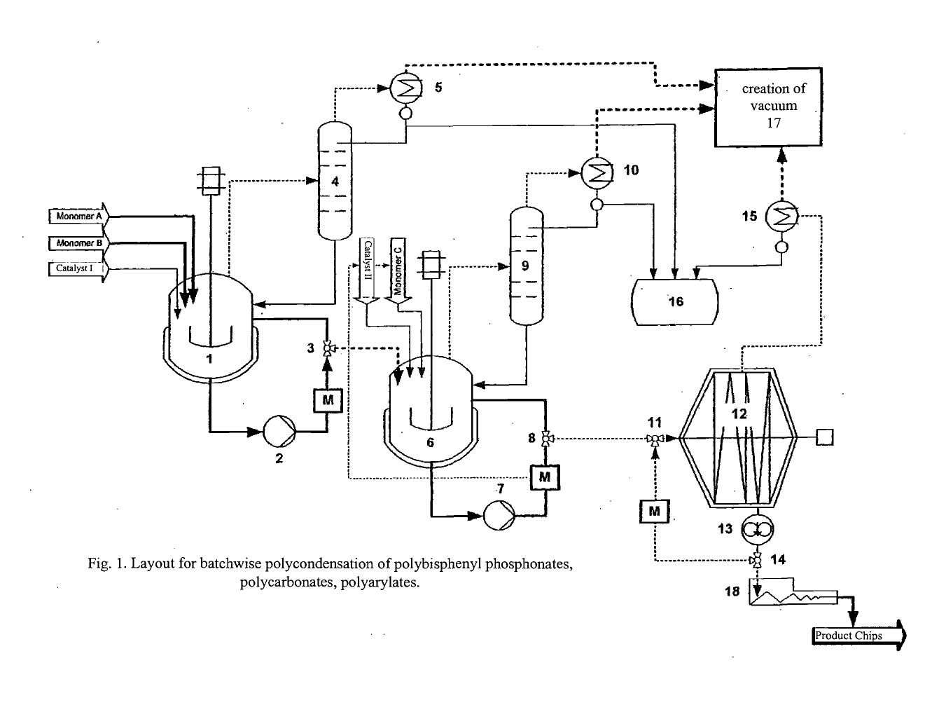

These methods are represented, for example, in FIGS. 1, 2, and 3.

One delivers the monomer or monomers in batches via charging locks under inert atmosphere into monomer receivers (not depicted in the figure). From these receivers, specifically determined masses depending on the quantity of polymer to be produced in the batch, insofar as such are present as a solid at ambient temperature, are fed as powderlike monomers into the first reactor 1. Monomers which are liquid at ambient temperature go from inertized receivers by means of gas-tight delivery structures to the reactor 1. A dosing of the monomers in excess of the equimolar 1:1 is undertaken, depending on the volatility of the monomers under the desired reaction conditions. In order to maintain a constant concentration of the monomers escaping together with the cleavage products during the reaction, the vapors are taken to a rectification column 4. The operation of this column is managed such that the heavier volatile monomers collect in the bottom and are returned to the reactor 1. The lighter volatile cleavage products reach the top of the column 4, are precipitated in the condenser 5 and are returned to the column 4 in a partial stream as reflux. The reflux ratio is dependent on the effectiveness of the separation of the monomers by the column 4. Of course, the molar relations of cleavage product and monomer in the vapors change with increasing conversion in a batchwise operation, so that the operating conditions must abide by these circumstances.

The first reaction takes place in the esterification and/or reesterification stage in reactor 1 at rather high temperature and in presence of a suitable catalyst. The esterification or reesterification product obtained from this reactor is circulated by the pump 2 and the valve 3, per FIG. 1, until a predetermined dwell time is reached and the product can be fed by switching the valve 3 to the intermediate reactor 6, where additional monomers, such as those with tri-, tetra- and/or higher functional groups can be added all at once or one at a time. According to the invention, the constantly changing properties of the product flowing through the pump 7 and the valve 8 are monitored for example by continuous measurement of the rheological properties per German patent application DE 102 00 228, the change in the pressure wave behavior per German patent application DE 103 47 826, or the change in the spectroscopic properties by the method of the familiar FTIR or NIR-UV spectroscopy. It is especially advantageous to control the adding of the modifying monomers by ongoing monitoring of the properties of the polycondensate.

The additional cleavage products liberated with the previously reacted product during this secondary and/or subsequent reaction still contain portions of the monomers added. In order to provide for an economical use of these generally very costly products and not have to recover them from a strong dilution with the cleavage products, the vapors are taken to a rectification column 9. The operation of the column 9 is managed such that the heavier volatile monomers collect in the bottom and are returned to the reactor 9. The lighter volatile cleavage products reach the top of the column 9, are precipitated in the condenser 10 and are returned to the column 9 in a partial stream as reflux. The reflux ratio is dependent on the effectiveness of the separation of the monomers by the column 9. Of course, the molar relations of cleavage product and monomer in the vapors change with increasing conversion in a batchwise operation, so that the operating conditions must abide by these circumstances.

The polymer obtained from this reactor goes via the valves 8 and 11 per FIG. 1 to the polycondensation reactor 12, a specially configured final reactor, such as is described in European patent application 1 251 957. This reactor consists of a horizontally arranged receptacle, having a diameter to length ratio of 0.5:1 to 5:1, preferably 0.7:1.3 to 3:1. It contains an essentially horizontally propelled shaft with stirring elements affixed to it, by which the polyphosphonate, polyarylate, polysulfonate or polyether ketone as well as their copolymerizates are drawn by means of the gear pump 13 out from the final reactor 12. The pipelines are provided with a heated jacket, whose temperature lies at least 2° C. and at most 20° C. above the melting point of the product taken through the lines. The final reactor is preferably outfitted with static elements on the reactor walls to create thin films and to strip off entrained product on rotating disks, while the reactor shaft only has a lead-through in the lids at both ends.

The precondensate is polycondensed in the final reactor at a melt dwell time of 5 minutes to 15 hours and preferably 15 to 600 minutes. One maintains the temperatures in the reactor 1 and/or in the intermediate reactor 6 in the range of 180 to 300° C., while the temperature in the final reactor 12 is increased to the range of 240 to 400° C. Using a steam injector and/or mechanical blower 17, the vapors liberated during the reaction are sucked out from each reactor and the pressure in the esterification and/or reesterification reactor 1 and in the intermediate reactor 6 is lower continuously or gradually from 2000 to 100 mbar and that in the final reactor at 100 to 0.1 mbar. It has proven to be especially beneficial to slowly lower the pressure linearly or in stages in reactor 1 only after reaching full reesterification and a first precondensation with chain repetition units of up to 20 structural units. In this way, one can hinder the formation of large gas bubbles, which might burst and result in polymer particles being entrained by the vapor stream of gas or cleavage product.

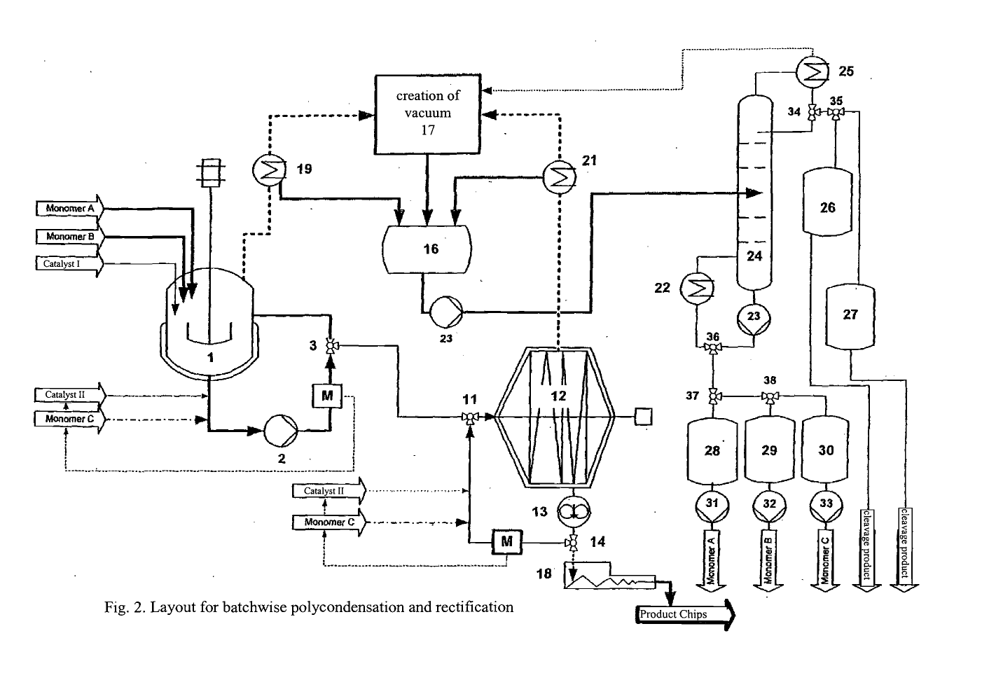

The process concept shown in FIG. 2 is especially favorable when one needs to hold down the costs of the apparatus equipment. The production of the aforementioned polymers is solved here in that one delivers the monomers in batches via charging locks from monomer receivers (not shown) standing under an inert atmosphere. From these receivers, specifically determined masses depending on the quantity of polymer to be produced are fed into the first reactor 1. If the monomers are present as a solid at ambient temperature, they are added in powder form. If they are liquid at ambient temperature, the monomers are taken from inertized receivers by means of gas-tight delivery structures to the reactor 1. A dosing of the monomers in excess of the equimolar 1:1 ratio is carried out, depending on the volatility of the monomers under the desired reaction conditions.

In a departure from the process illustrated in FIG. 1, here there is no rectification of the monomers escaping together with the cleavage products during the reaction. The vapors escaping from the reactor are precipitated in the condenser 5 and are taken to the condensate collector tank 16.

The first reaction takes place in the esterification and/or reesterification stage in reactor 1 at rather high temperature and under addition of catalyst. The esterification or reesterification product obtained herein is circulated by the pump 2 and the valve 3, per FIG. 2, until a predetermined viscosity is reached, and the product is then fed by switching the valve 3 to the final reactor 12. The adding of additional monomers, such as those with tri-, tetra- and/or higher functional groups, is done all at once or one at a time in the circulation line going to the reactor 1. According to the invention, the constantly changing properties of the product pumped through the pump 2 and the valve 3 are monitored for example by continuous measurement of the rheological properties per DE 102 00 228, the change in the pressure wave behavior per DE 103 47 826, or the change in the optical properties by the method of the familiar FTIR, NIR, or UV spectroscopy. It is especially advantageous to add the modifying monomers in dependence on a monitoring of the properties of the condensate.

The additional cleavage products liberated with the previously reacted product during this secondary and/or subsequent reaction are likewise condensed and collected in the tank 16. The polymer obtained from the reactor 1 goes via the valves 3 and 11 per FIG. 2 to the final polycondensation reactor 12, a specially configured final reactor, such as is described in EP 1 251 957, for example. These reactors have an essentially horizontally arranged shaft with stirring elements affixed to it, and the resulting polycondensate is drawn by means of a gear pump 13 out from the final reactor. The valve 14 is adjusted so that the polycondensate is returned to the reactor 12 via the valve 14 until the desired level of polycondensation is achieved. After achieving the end of the polycondensation, the valve 14 is switched so that the end product is taken by means of pump 13 to the granulator 18 and there, after rapid cooling, it is cut into polymer chips.

The vapors sucked from the reactor 12 are precipitated in the condenser 21 and collected in the tank 16. After completion of the production of the particular batch, the entire condensate is taken by means of pump 23 to distillation and rectification 24, where the lighter volatile products are at first driven off at the top. The column 24 is operated such that the heavier volatile monomers collect at the bottom and are caught in the tanks 28, 29, 30. The lighter volatile cleavage products reach the top of the column 24, are precipitated in the condenser 25 and are returned to the column 24 in a partial stream as reflux. The reflux ratio, defined as the part of the product after 24 to the part supplied to the collecting tanks 26, 27 via valve 34, 35, is dependent on the effectiveness and the substance being rectified.

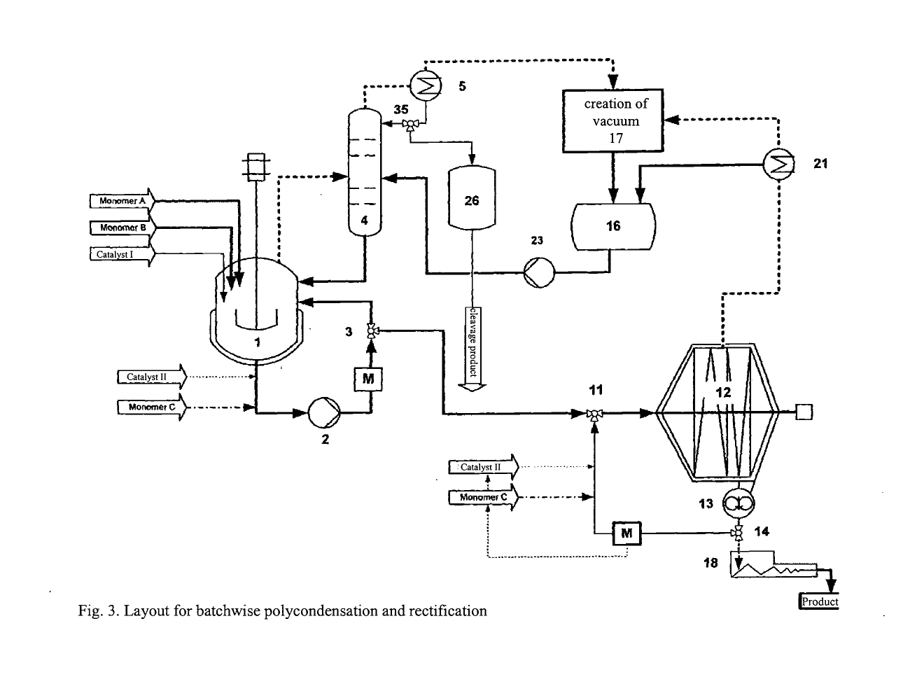

In departure from the method illustrated in FIGS. 1 and 2, in the method represented in FIG. 3 there is a simultaneous rectification of the monomers escaping with the cleavage products during the reaction. These escape from the reactor 1 as vapors and are taken to the column 4, where the monomers with higher boiling point than the cleavage products are precipitated and taken to the reactor 1 as vat product. The low-boiling components or cleavage products rising to the top are condensed in the condenser 5. The condensate is divided into column reflux and outwardly transferred product, which is taken to the condensate collection tank 16.

The first reaction of the monomers A and B takes place in the esterification and/or reesterification stage in reactor 1 at rather high temperature and under addition of catalyst I. The esterification or reesterification product obtained herein from A and B is circulated by the pump 2 and the valve 3, per FIG. 3, until a predetermined viscosity is reached. After this, it is fed by switching the valve 3 to the final reactor 12. The adding of additional monomers, such as those with tri-, tetra- and/or higher functional groups, is done all at once or one at a time in the circulation line going to the reactor 1. According to the invention, the constantly changing properties of the product pumped through the pump 2 and the valve 3 are monitored for example by continuous measurement of the rheological properties per DE 102 00 228, the change in the pressure wave behavior per DE 103 47 826, or the change in the optical properties by the method of the familiar FTIR, NIR, or UV spectroscopy. It is especially advantageous to add the modifying monomers C and/or an additional catalyst II in dependence on a monitoring of the properties of the condensate.

The additional cleavage products liberated with the previously reacted product during this secondary and/or subsequent reaction are taken to the rectification 4 in order to separate the monomers. The polymer obtained from the reactor 1 goes via the valves 3 and 11 per FIG. 3 to the final polycondensation reactor 12, a specially configured final reactor, such as is described in EP 1 251 957, for example. This reactor has an essentially horizontally driven shaft with stirring elements affixed to it, and the resulting polycondensate is drawn by means of a gear pump 13 out from the final reactor. The valve 14 is adjusted so that the polycondensate is returned to the reactor 12 via the valve 14 until the desired level of polycondensation is achieved. After achieving the end of the polycondensation, the valve 14 is switched so that the end product is taken by means of pump 13 to the granulator 18 and there, after rapid cooling, it is cut into polymer chips.

The vapors sucked from the reactor 12 are precipitated in the condenser 21 and collected in the tank 16. After completion of the production of the particular batch, the entire condensate is taken from 16 by means of pump 23 during the next charging to the distillation and rectification 4, where the lighter volatile products are at first driven off at the top. The column 4 is operated such that the heavier volatile monomers collect at the bottom and are returned to the reactor 1. The lighter volatile cleavage products reach the top of the column 4, are precipitated in the condenser 5 and are returned to the column 4 in a partial stream as reflux by the valve 35. The reflux ratio, is dependent on the type and design of the column installed structures and the substance being rectified and must be adapted during the time course of the reaction in order to achieve an optimal separation effect.

For the production of polycondensates according to the invention one will use, for example, monomeric phosphate components, dihydroxydiphenyl and other bisphenols and diphenyl esters of methylphosphonic acid. Especially suitable as the diphenol or dialcohol components are the diphenols known in the trade under the brand “Bisphenol A to F”, but other diphenols can also be used.

Suitable as the reesterification catalysts are organometal compounds such as zinc acetate or sodium phenolate, which are described for example in DE 31 11 653, as well as other organometal compounds, which have been presented in D. Braun, H. Cherdron, H. Ritter in “Practicum of macromolecular substances”, Wiley-VCH Verlag, Weinheim, 1999. The temperatures and pressures used in the different reactors have major influence on the product properties in the method of the invention. The quality of the polycondensate obtained according to the invention is influenced in decisive manner by the form of the reactor, since this will govern the dwell time, the material exchange, the surface renewal capacity and the self-cleaning behavior, which particularly determine the properties of the polycondensate. Stirred tanks or series of such tanks are well suited to the first step, the melting, the achieving of a stoichiometric ratio of the monomers, the adding of catalyst and the incipient reaction. These are only of limited suitability for the following polycondensation, during which increasingly more viscous products are formed as the chain continues to grow, and then only if special mixing elements are installed and the stirring element is adapted to the changing polymer properties. For the continuously changing product properties under increasing condensation and growing chain length, the annular disk reactor types as described in EP 1 251 957 and their modified designs for batchwise operation should be preferred as the intermediate reactor or also the final reactor. To promote the venting of cleavage products, which are released in the course of the esterification, reesterification and polycondensation as the chain continues to lengthen, one steadily reduces the pressure in the individual reactors. To create a vacuum in the reactors, one can use steam injectors, such as are described in the U.S. Pat. No. 5,576,414. It is recommended to make sure that the pressure in the immediately following reactor is at most half as high as in the immediately preceding reactor.

For the production of polymers which are given a structure deviating from the basic skeleton by the adding of an additional monomer, one can utilize various methods. One variant of the method according to the invention calls for adding a further monomer during the condensation occurring in the intermediate reactor 6 and then continuing the polymerization and/or the graft reaction in this reactor under the same or different conditions as are prevailing in the first reactor, it being possible to form star, comb, bush, tree and dendrimer shaped branching structures in regular and statistical distribution. In such a graft reaction and/or chain branching, besides the additional monomer, one can also add a further catalyst, as well as stabilizers, flow improvers, and solid-containing additives, which might lead to a contamination of the reactor and be troublesome during subsequent reaction in the same reactor when a complete emptying and cleaning of the reactor is not possible. Such a contamination of the monomers in the basic polymer batch with the other added substances is not advantageous for reactor 1, since it can lead to unwanted secondary reaction and/or different product properties than those wanted.

A three-stage process layout has the benefit that one can raise the temperature in the subsequent reactors in stages and thus also regulate the partial vacuum need to suck away the cleavage products and adapt the economical circumstances. In this way, low initial temperatures can be set at the start of the polycondensation in the case of short chains of molecules and when the polymer melting point is still low. Large quantities of cleavage products are also formed at the start of the polycondensation and it is economically beneficial and industrially advantageous to suck these away with only slight partial vacuum, in which case one can also work with more economical pumps or steam injectors. In practice, steam or liquid injectors have proven to be especially reliable in operation for this purpose, whereas the operation with mechanical blowers involves high investment expense, but offers the highest energy efficiency. The adding of a branching molecule in this phase results in long-chain branching, which in turn has its own branching and thus can have the structure of a dendrimer or tree.

The polymer chains grow with increasing reaction time and reaction temperature, so that chain lengths of 15 to 35 structural units are achieved in the intermediate reactor 6 and chain lengths of 30 to 100 structural units in the final reactor 12. The viscosity of the melt increases in this process and it becomes necessary to configure the polycondensation reactor with special rheological properties. The inner space of such a reactor can depart from cylindrical form, for example, it can also have a conical form. The adding of a branching molecule in this phase results in branching with short and/or medium length and exhibiting a more or less bush and/or comb-like structure.

The invention shall be explained more closely by the following examples:

### EXAMPLE 1

The monomers bisphenol A, hereinafter abbreviated as BPA, and diphenylmethyl phosphonate, hereinafter abbreviated as DPMP, delivered as crystallized, pulverized or pelletized raw material, are poured into receiving tanks and taken continuously by means of dispensing worms to melting vessels, outfitted with heat exchangers and stirring mechanisms. From the two receiving tanks, the aliquot mass flows of molten monomers as determined by the stoichiometry of the reaction are delivered to the reesterification tank 1, which is outfitted with a heating jacket and a stirring element. From a receiver, the mixed catalysts known from the polymer literature are added, consisting of an alkaline salt of bisphenol and zinc acetate, as described in patent DE 31 11 653. The reaction of the two monomers is initiated at a temperature of 240° C. and a pressure of 800 mbar. The liberated phenol is captured and volumetrically determined to determine the progress of the reaction. The reesterified product from reactor 1 still has a low average polymer chain length, being on average 10 units or repetition or structural units, and still has slight amounts of unreacted monomers, due to the dwell time behavior in the stirred tank. The molecular weight distribution, the residual content of monomers and the mean molecular weight of the reesterification product are monitored by means of chromatography. This product goes to the intermediate reactor 6, which is operated at a pressure of 200 mbar. Here, a continuous heating from 240 to 280° C. takes place over 2.5 hours. The resulting cleavage products are sucked out by a multistage liquid-steam injector system 17 and, after a rectification at a temperature lying above the boiling point of the cleavage product and below the boiling temperature of the monomer contained in the vapor, precipitated in the condenser 5. From the intermediate stage 6, the product goes to the final reactor 12 by means of a pump 7, where at a pressure of 1.5 mbar, a temperature of 330° C., and a dwell time of 200 minutes the polycondensation is completed. Provision is made for the increasing viscosity or chain length during the dwell time in that the rotating disks, ring disks and ring disk segments needed to create the surface are cleaned by statistical elements. Especially suited to this purpose is HVSR, Kunststoffe 1/1992, p. 10-20. The product leaving the final reactor 12 has only slight yellow discoloration from decomposition products, extremely slight portions of gel and black particles, and a narrow molecular weight distribution.

### EXAMPLE 2

In an experimental layout consisting of the reactors in FIG. 1 and a method of operation as described in Example 1, an esterification stage 1 is supplied from three receivers with terephthalic acid, isophthalic acid, and bisphenol A in a molar ratio of 1:0.75:1.75. Catalyst in the form of an alkaline salt of bisphenol is added from a receiver. The reaction of the monomers is initiated at a temperature of 280° C. and a pressure of 800 mbar. The water liberated is captured and used to determine the progress of the reaction by volumetry. The esterified product from reactor 1 goes, similarly to example 1, to the intermediate reactor 6, which is operated at a pressure of 250 mbar. Here, there is added 10⁻³ mol of diphenylmethyl phosphonate per mol of bisphenol and the product undergoes a continuous heating from 280 to 300° C. during a dwell time of 145 minutes. The product condenses further and the resulting cleavage product is sucked away by the multistage liquid-steam injector system. From the intermediate reactor 6, after the end of the reaction time, the product goes by means of pump 7 and valve 8 to the final reactor 12, which is kept at pressure of 25 mbar and in which the temperature continuously rises from the exit temperature of the intermediate reactor 6 to a temperature of 320° C. during 60 minutes dwell time. From the reactor 12, where the polycondensation is completed at a pressure of 0.5 mbar, a temperature of 330° C. and a dwell time of 65 minutes, the product goes by means of a gear pump 13 to the granulator 18. The product leaving the granulator 18 has only slight yellow discoloration from decomposition products, extremely slight portions of gel and black particles, and a narrow molecular weight distribution.

### EXAMPLE 3

In an experimental layout as described in Example 1, an esterification stage 1 is supplied from three receivers with terephthalic acid, isophthalic acid, and bisphenol A in a molar ratio of 1:0.75:1.75. Catalyst in the form of an alkaline salt of bisphenol A is added from a receiver. There is added 10⁻³ mol of 1,3,5-trihydroxyphenol per mol of bisphenol in the intermediate reactor 6 and a continuous heating from 240 to 280° C. occurs over 2.5 hours.

### EXAMPLE 4

In an experimental layout as described in Example 1, an esterification stage 5 is supplied from four receivers with terephthalic acid, isophthalic acid, p-phenylene diamine, and o-phenylene diamine in a molar ratio of 1:1:1.03:1. Catalyst in the form of an organotitanium compound is added from a receiver. The reaction of the monomers is initiated at a temperature of 180° C. and a pressure of 1000 mbar.

### LIST OF REFERENCE NUMBERS

1 esterification/reesterification reactor (first stage)
2 circulation/transfer pump (first stage)
3 switching valve for circulation/transfer (first stage)
4 rectification column (first stage)
5 vapor condenser (first stage)
6 intermediate reactor (second stage)
7 circulation/transfer pump (second stage)
8 switching valve for circulation/transfer (second stage)
9 rectification column for intermediate stage (second stage)
10 vapor condenser for intermediate stage (second stage)
11 switching valve for circulation/transfer (final stage)
12 polycondensation reactor (final stage)
13 gear pump for circulation/outward transfer (final stage)
14 switching valve for circulation/outward transfer (final stage)
15 vapor condenser for polycondensation reactor (final stage)
16 collecting tank
17 vacuum generation station
18 granulator
19 vapor condenser for esterification/reesterification reactor
20 . . .
21 vapor condenser for polycondensation reactor
22 circulation/transfer pump for rectification
23 heat exchanger for rectification
24 rectification column
25 vapor condenser for rectification
26 collecting tank cleavage product
27 collecting tank cleavage product
28 collecting tank monomer A-C
29 collecting tank monomer A-C
30 collecting tank monomer A-C
31 delivery pump monomer A-C
32 delivery pump monomer A-C
33 delivery pump monomer A-C
34 switching valve for circulation/collecting tank
35 switching valve for circulation/collecting tank
36 switching valve for circulation/collecting tank
37 switching valve for circulation/collecting tank
38 switching valve for circulation/collecting tank
M continuous measurement, monitoring and control

1. Method for batchwise production of high-molecular polyphosphonates, polysulfones, polyarylates, (polyamides), polyarylene ethers, or polyether ketones by melt-condensation of a monomer compound carrying hydroxyl groups, carboxyl groups, anhydride groups, phosphoric acid groups, phosphono groups, phosphonate groups, phosphino groups, phosphinate groups, carbonyl groups, sulfonyl groups, sulfonate groups, siloxane groups or amino groups on its own or along with at least one diphenol, dialcohol, diamine, or a dicarbonate component, characterized in that
a) an esterification or reesterification and a precondensation are performed in a batchwise operated first reactor (1) in the presence of an esterification or reesterification catalyst;
b) a polycondensation is then optionally performed in a batchwise operated intermediate reactor (6) by optionally adding one or several additional monomers, another catalyst, and additives, until a predetermined polycondensation level or viscosity level has been attained and
c) finally the condensation is continued in a batchwise operated final reactor (12) until the desired polycondensation level or viscosity level has been reached and
d) branching molecules comprising more than two functional groups are optionally added,
prior to or during esterification or reesterification,
prior to or during polycondensation optionally performed in the intermediate reactor,
or prior to or during polycondensation performed in the final reactor,
wherein a residence time in the reactors between 5 minutes and 15 hours is observed, the temperature is set to 180 to 300° C. in reactors (1) and (6) and to 240 to 400° C. in reactor (12), and the pressure is continuously or gradually lowered from 2000 to 100 mbar in reactors (1) and (6) and to 100 to 0.01 mbar in reactor (12) by sucking off the vapors produced during the condensation.

2. Method according to claim 1, characterized in that the precondensate obtained in the first reactor (1) is taken directly to the final reactor (12) while at the same time adding one or more additional monomers, an additional catalyst, and possibly other additives, and omitting the intermediate reactor (6), and a polycondensation is performed there until achieving a predetermined level of polycondensation or viscosity, while the monomers escaping with the cleavage products formed during the condensation reactions are collected as condensates and then subjected to distillation.

3. Method according to claim 1, characterized in that the monomers escaping as vapor together with the cleavage products during the production of the precondensate in the first reactor (1) are returned to the first reactor (1), while the cleavage products are transferred to the outside as condensates and the precondensate formed in the first reactor is taken directly to the final reactor (12) after adding one or more additional monomers, an additional catalyst, and possibly other additives, and omitting the intermediate reactor (6), and a polycondensation is performed there until achieving a predetermined level of polycondensation or viscosity.

4. Method according to claim 1, comprising recovering monomers from the cleavage products by fractionated condensation and/or distillation and returning them to the process.

5. Method according to claim 1, characterized in that the pressure in the reactors is lowered linearly or by stages and is at most only half as high in the immediately following reactor as in the immediately preceding reactor.

6. Method according to claim 1, characterized in that the esterified and/or reesterified precondensate produced in the reactor (1) has average chain lengths of up to 20 structural units.

7. Method according to claim 1, characterized in that the product obtained from the intermediate reactor (6) has average chain lengths of 15 to 35 structural units.

8. Method according to claim 1, characterized in that the product obtained from the final reactor (12) has average chain lengths of 30 to 100 structural units.

9. Method according to claim 1, comprising monitoring the course of the condensation reaction by continuous measurement of the rheological properties, the change in the pressure wave behavior, and/or the change in the optical properties.

10. Method according to claim 1, comprising controlling the rheological properties of the condensation product by adding additional monomers, stabilizers, flow improvers and/or additives.

11. Method according to claim 1, comprising keeping the product in each reactor during the particular residence time in the circulation.
diameter to length of 0.5:1 to 5:1, preferably 0.7:1.3 to 3:1, and the pipelines are provided with a heated jacket, whose temperature is at least 2° C. and at most 20° C. above the melting point of the product taken through the pipeline.

13. Device according to claim 12, characterized in that the end reactor (12) is outfitted with static elements on the reactor walls to create thin films and to strip off entrained product on rotating disks.

14. Device according to claim 12, characterized in that the reactor shaft of the horizontal final reactor (12) has only one lead-through through the lids at either end.

15. Method according to claim 2, comprising recovering monomers from the cleavage products by fractionated condensation and/or distillation and returning them to the process.

16. Method according to claim 3, comprising recovering monomers from the cleavage products by fractionated condensation and/or distillation and returning them to the process.

17. Method according to claim 2, characterized in that the pressure in the reactors is lowered linearly or by stages and is at most only half as high in the immediately following reactor as in the immediately preceding reactor.

18. Method according to claim 3, characterized in that the pressure in the reactors is lowered linearly or by stages and is at most only half as high in the immediately following reactor as in the immediately preceding reactor.

19. Method according to claim 4, characterized in that the pressure in the reactors is lowered linearly or by stages and is at most only half as high in the immediately following reactor as in the immediately preceding reactor.

20. Method according to claim 2, characterized in that the esterified and/or reesterified precondensate produced in the reactor (1) has average chain lengths of up to 20 structural units.

21. Method according to claim 3, characterized in that the esterified and/or reesterified precondensate produced in the reactor (1) has average chain lengths of up to 20 structural units.

22. Method according to claim 4, characterized in that the esterified and/or reesterified precondensate produced in the reactor (1) has average chain lengths of up to 20 structural units.

23. Method according to claim 2, characterized in that the product obtained from the intermediate reactor (6) has average chain lengths of 15 to 35 structural units.

24. Method according to claim 3, characterized in that the product obtained from the intermediate reactor (6) has average chain lengths of 15 to 35 structural units.

25. Method according to claim 4, characterized in that the product obtained from the intermediate reactor (6) has average chain lengths of 15 to 35 structural units.

26. Method according to claim 6, characterized in that the product obtained from the intermediate reactor (6) has average chain lengths of 15 to 35 structural units.

27. Method according to claim 2, characterized in that the product obtained from the final reactor (12) has average chain lengths of 30 to 100 structural units.

28. Method according to claim 3, characterized in that the product obtained from the final reactor (12) has average chain lengths of 30 to 100 structural units.

29. Method according to claim 4, characterized in that the product obtained from the final reactor (12) has average chain lengths of 30 to 100 structural units.

30. Method according to claim 26, characterized in that the product obtained from the final reactor (12) has average chain lengths of 30 to 100 structural units.

31. Device to implement the method of claim 2, characterized in that at least the final reactor (12) consists of a horizontally arranged tank and this has a ratio of diameter to length of 0.5:1 to 5:1, preferably 0.7:1.3 to 3:1, and the pipelines are provided with a heated jacket, whose temperature is at least 2° C. and at most 20° C. above the melting point of the product taken through the pipeline.

32. Device to implement the method of claim 3, characterized in that at least the final reactor (12) consists of a horizontally arranged tank and this has a ratio of diameter to length of 0.5:1 to 5:1, preferably 0.7:1.3 to 3:1, and the pipelines are provided with a heated jacket, whose temperature is at least 2° C. and at most 20° C. above the melting point of the product taken through the pipeline.

33. Device to implement the method of claim 4, characterized in that at least the final reactor (12) consists of a horizontally arranged tank and this has a ratio of diameter to length of 0.5:1 to 5:1, preferably 0.7:1.3 to 3:1, and the pipelines are provided with a heated jacket, whose temperature is at least 2° C. and at most 20° C. above the melting point of the product taken through the pipeline.

34. Device according to claim 13, characterized in that the reactor shaft of the horizontal final reactor (12) has only one lead-through through the lids at either end.
